(19) United States
(12) Patent Application Publication
(10) Pub. No.: US 2017/0217151 A1
(43) Pub. Date: Aug. 3, 2017

(54) SCREEN PRINTING APPARATUS AND METHODS

(71) Applicant: CORNING INCORPORATED, CORNING, NY (US)

(72) Inventors: Thomas Cutcher Jr., Berkey, OH (US); Christopher Paul Daigler, Painted Post, NY (US); Christina Marie Laskowski, Painted Post, NY (US); Kevin Ray Maslin, Athens, PA (US)

(21) Appl. No.: 15/500,385

(22) PCT Filed: Jul. 31, 2015
(86) PCT No.: PCT/US15/43169

§ 371 Date: Jan. 30, 2017

Related U.S. Application Data
(60) Provisional application No. 62/032,156, filed on Aug. 1, 2014.

(51) Int. Cl. B41F 15/38; B41F 17/00; B41F 15/44

(52) U.S. Cl. CPC B41F 15/38; B41F 15/44; B41F 17/00

(57) ABSTRACT

Disclosed herein are apparatuses for screen printing on a surface of a three-dimensional substrate comprising a substantially rigid, substantially planar frame having a perimeter defining a region within the perimeter having a given surface area; and a screen attached to the frame and extending across at least a portion of the surface area, wherein the screen comprises a first portion through which a liquid printing medium can pass onto a proximate three-dimensional substrate; and a second portion coated with an emulsion substantially preventing the liquid printing medium from passing through the second portion of the screen, wherein the screen has a fixed tension of less than about 20 N/cm. Methods and systems for screen printing on a surface of a three-dimensional substrate are also disclosed herein.

### CROSS-REFERENCE TO RELATED APPLICATIONS

This application claims the benefit of priority under 35 U.S.C. §119 of U.S. Provisional Application Ser. No. 62/032,156 filed on Aug. 1, 2014 the content of which is relied upon and incorporated herein by reference in its entirety.

### FIELD OF THE DISCLOSURE

The disclosure relates generally to methods and apparatuses for printing a pattern on three-dimensional substrates, and more particularly to screen printing methods and apparatuses for printing on substrates having one or more curved surfaces.

### BACKGROUND

Three-dimensional (3D) screen printing is widely used in various industries, e.g., for printing on rounded containers such as bottles and cans. 3D screen printing as yet is generally limited to substrates with a smaller radius of curvature (e.g., less than about 500 mm) and/or a single axis of curvature. For the most part, 3D printing is also limited to printing on the outside, or convex, surface of semi-circular or parabolic substrates and cylindrical substrates with circular or oval cross-sections. These substrates can typically comprise glass (e.g., bottles, mugs, glasses, etc.), plastic (e.g., containers, etc.), and/or metal (e.g., cans, castings, etc.).

The ability to screen print on larger format, larger radius, and/or multiple radius three-dimensional substrates is increasingly relevant to various industries, such as the automotive industry. Larger format 3D substrates conventionally can be printed while the substrate is still flat, followed by shaping of the substrate to achieve a 3D shape, e.g., by softening a glass or plastic substrate at elevated temperatures, or the like. However, because the printing medium can be thermally incompatible with the conditions necessary to shape the substrate after printing, there is a growing need to print on curved surfaces of large format 3D substrates. This is particularly true in the case of glass substrates, which can be heated to relatively high forming or softening temperatures during the shaping process.

Current methods for decorating the surfaces of a 3D substrate include masking a portion of the surface and spray coating the substrate to create an image; however, such methods can be costly and/or time consuming and generally do not provide a suitable image resolution. Screen printing and inkjet printing on large format curved surfaces have been attempted, but with various drawbacks, complications, and/or limitations. For instance, 3D printing devices typically comprise one or more extra moving parts as compared to 2D printing devices for purposes of maintaining an “off-contact” distance, or gap, between the substrate and the screen mesh. 2D flat screen printing processes generally maintain a constant off-contact distance ranging from about 1 to about 10 mm, depending on the printing application. 3D printing devices conventionally compensate for off-contact variability by articulating the substrate under the screen or articulating the screen above or around a fixed substrate.

Screen frames with flexible sides can also be used, such that the frame and mesh can conform somewhat to the contour of the curved substrate during printing. Screen frames pre-shaped to match the curvature of a given substrate can also be used. Devices used to tension and de-tension the screen mesh can also be attached to a screen frame to allow the mesh to conform or flex during the printing process. However, these additional components and/or features of the screen frame and/or printing machine can add to the complexity and/or expense of the 3D printing process, as the printing machines and/or their individual components often have to be custom tailored to achieve each desired feature. Moreover, such 3D screen printing methods can be used only for convex or concave surface printing, not both, and only for substrates with a single radius of curvature.

Accordingly, it would be advantageous to provide methods and apparatuses for screen printing 3D substrates, which can operate with fewer moving parts, at lower cost, and/or with lower complexity. It would additionally be advantageous to provide methods and apparatuses for printing on a variety of substrate shapes, such as concave and/or convex substrates, and/or substrates with a complex curvature, e.g., curvature around plural radii. Furthermore, to reduce manufacturing costs and/or the need to custom make the printing device and/or its components, it may be advantageous to provide an apparatus that can function, at least in part, in conjunction with existing components for printing traditional (e.g., 2D) substrates.

### SUMMARY

The disclosure relates, in various embodiments, to apparatuses for screen printing on a surface of a three-dimensional substrate, the apparatuses comprising a substantially rigid, substantially planar frame having a perimeter defining a region within the perimeter having a given surface area; and a screen attached to the frame and extending across at least a portion of the surface area, the screen comprising a first portion through which a liquid printing medium can pass onto a proximate three-dimensional substrate; and a second portion coated with an emulsion substantially preventing the liquid printing medium from passing through the second portion of the screen, wherein the screen has a fixed tension of less than about 20 N/cm. The disclosure also relates to systems for screen printing on a surface of a three-dimensional substrate, the systems comprising a framed screen apparatus as disclosed herein, and an applicator for applying a liquid printing medium to the three-dimensional substrate.

The disclosure further relates to methods for screen printing on a surface of a three-dimensional substrate, the methods comprising positioning the three-dimensional substrate in proximity to a framed screen apparatus as disclosed herein; applying a liquid printing medium to the screen; and applying pressure to the screen to force the liquid printing medium through at least a portion of the screen, wherein the distance between the frame and the three-dimensional substrate is held substantially constant during the application steps.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals and in which:

FIG. 1 illustrates a top view of an exemplary screen printing apparatus according to one embodiment of the disclosure;

FIG. 2 illustrates a top view of an exemplary screen printing apparatus according to another embodiment of the disclosure; and

FIG. 3 illustrates a side view of an exemplary screen printing system according to one embodiment of the disclosure.

### DETAILED DESCRIPTION

Apparatuses

Disclosed herein are apparatuses for screen printing on a surface of a three-dimensional substrate, the apparatuses comprising a substantially rigid, substantially planar frame having a perimeter defining a region within the perimeter having a given surface area; and a screen attached to the frame and extending across at least a portion of the surface area, the screen comprising a first portion through which a liquid printing medium can pass onto a proximate three-dimensional substrate; and a second portion coated with an emulsion substantially preventing the liquid printing medium from passing through the second portion of the screen, wherein the screen has a fixed tension of less than about 20 N/cm.

As used herein, the term “three-dimensional substrate” and variations thereof is intended to denote a substrate having at least one non-planar and/or non-level surface, e.g., a surface with any given curvature, which may vary in size, shape, and/or orientation. A two-dimensional substrate, by contrast, comprises flat, planar, level surfaces, such as a flat sheet or a block.

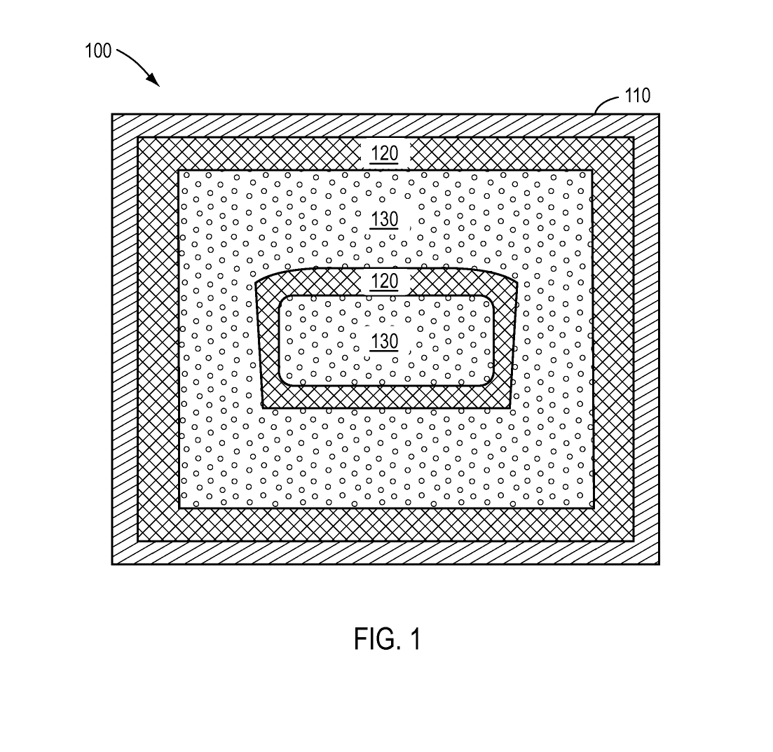

With reference to FIG. 1, one embodiment of an exemplary screen printing apparatus 100 according to the disclosure is illustrated, which comprises a frame 110 and a screen 120. The screen 120 is partially coated with an emulsion 130 to form a pattern or image. In the illustrated embodiment, the pattern may correspond to a vehicle roof or sunroof, although various other shapes and applications are envisioned.

As used herein, the term “frame” is intended to denote the component forming a substantially rigid perimeter around the screen. The terms “screen,” “mesh screen” and variations thereof are intended to denote a material extending across the frame and covering, at least in part, the surface area defined by the frame. As used herein, the terms “apparatus,” “framed screen apparatus,” “framed screen,” and variations thereof are intended to denote the combined frame and screen components, e.g., the screen affixed to the frame, optionally with the addition of the emulsion.

The frame 110 may have any shape and size suitable for supporting a screen printing screen for a particular application. For instance, the frame may define a perimeter having a shape chosen from a square, rectangle, rhombus, circle, oval, ellipse, triangle, pentagon, hexagon, and other polygons, to name a few. According to various embodiments, the frame is four-sided, e.g., defining a square, rectangular, or rhomboid perimeter. The frame can be planar or substantially planar, and substantially rigid or inflexible. In other words, the frame is not shaped to conform to the curvature of the three-dimensional substrate before printing (substantially planar), and is not configured to conform to the curvature of the three-dimensional substrate during printing (substantially rigid).

The dimensions of the frame 110, e.g., length, width, diameter or height, depending on the geometry, can be of any size suitable to adequately stretch the screen to provide an acceptable print resolution. The size of the frame can vary, for example, based upon the screen material, mesh count, mesh type, desired screen tension, and/or the size of the three dimensional substrate. In certain embodiments, the frame can have at least one dimension that is approximately equal to or larger than the largest dimension of the three-dimensional substrate, for example, at least about 1.5 times the largest dimension of the substrate, or at least about 2 times the largest dimension of the substrate.

By way of non-limiting example, the cross-sectional dimensions of an exemplary four-sided frame can range from about 25 mm×25 mm up to about 200 mm×200 mm or more, depending, e.g., on the size of the printing device. For instance, an exemplary four-sided frame can have dimensions ranging from about 35 mm×35 mm up to about 150 mm×150 mm, such as from about 50 mm×50 mm up to about 100 mm×100 mm, or from about 60 mm×60 mm to about 80 mm×80 mm, including all ranges and subranges therebetween, and including both square and rectangular variations. According to at least one non-limiting embodiment the frame may be a rectangle having a width approximately equal to twice the height of the frame. For example, the frame can be a rectangle having width×height dimensions of approximately 50 mm×25 mm, 60 mm×30 mm, 76 mm×38 mm, 100 mm×50 mm, 150 mm×75 mm, or 200 mm×100 mm. In some embodiments, the frame may have at least one dimension in excess of 1 meter, such as several meters or more, such as two or three meters or greater.

The frame 110 can be constructed from a substantially rigid material, which can be chosen from any suitable material to which the mesh screen can be attached. Exemplary materials include, but are not limited to, wood and metals, such as aluminum, extruded or hollow aluminum, stainless steel, hollow stainless steel, and the like. According to one non-limiting embodiment, the frame can be constructed from aluminum, such as extruded aluminum, hollow aluminum, or a bent aluminum piece. The frame thickness can vary, depending on the structural integrity desired for a particular application. In various embodiments, the frame can have a thickness ranging from about 2 mm to about 5 mm, such as from about 3 mm to about 4 mm, including all ranges and subranges therebetween.

The screen 120 can comprise one or more porous, flexible mesh materials suitable for screen printing applications, for example, polyesters, nylons, PETs, polyamides, polyester core/sheath combinations, composite polyester materials, and coated polyesters, to name a few. According to certain embodiments, the screen is chosen from non-metal mesh materials. The screen material can optionally be chosen from monofilament materials. The screen may comprise a mesh material with any suitable weave including, but not limited to, plain, twill, double twill, crushed, and flattened weave patterns.

The mesh count of the screen can vary depending, for instance, on the frame size, mesh type, thread diameter, and/or desired screen tension. By way of non-limiting example, the mesh count can range from about 120 threads/inch to about 380 threads/inch, such as from about 230 threads/inch to about 305 threads/inch, including all ranges and subranges therebetween. In various embodiments, the mesh count may be variable across the screen. For example, the mesh count can be varied across the screen depending on the curvature of three-dimensional substrate, the desired features to be printed, their location on the substrate, and/or the desired resolution. According to exemplary embodiments, a finer mesh count can be used on portions of the screen aligning with targeted features to be printed along the radius of curvature of the three-dimensional substrate.

The screen 120 can comprise materials with any suitable thread diameter available for any mesh count, so long as the screen maintains adequate flexibility and printing resolution. In various non-limiting embodiments, the thread diameter of the screen can range from about 30 microns to about 80 microns, such as from about 40 microns to about 70 microns, or from about 50 microns to about 60 microns, including all ranges and subranges therebetween.

It is to be understood that the foregoing properties of the screen and frame can be chosen, independently or in combination, as desired by one skilled in the art, to achieve a framed screen apparatus with the desired attributes for a particular application. For example, these properties can be chosen to achieve a suitable screen flexibility or tension, as discussed in more detail herein. Such choices are within the ability of one skilled in the art and are intended to fall within the scope of the disclosure.

The screen 120 can be attached to the frame 110 using any means known in the screen printing art, for example, the screen can be adhered to the frame using an adhesive. According to various embodiments, the screen may or may not be biased to the frame before being attached to the frame. Adhesives can include, for example, ethylene vinyl acetate (EVA), thermoplastic polyurethane (TPU), polyester (PET), acrylics (e.g., acrylic pressure sensitive adhesive tape), polyvinyl butyral (PVB), ionomers such as SentryGlas® ionomer, pressure sensitive adhesives, double-sided tape, or any other suitable adhesive material. Alternatively, the screen may be attached to the frame using other methods, such as frictional forces, e.g., using clips, clamps, or the like.

The screen 120 as disclosed herein can be a flexible mesh, which can denote that the screen has a fixed, low tension before and/or after being attached to the frame 110. According to various embodiments, the screen can have a fixed tension of less than about 20 N/cm after being attached to the frame. For example, the mesh can have a fixed tension that is distributed uniformly across the mesh, in both the warp and weft directions of the weave, of less than about 20 N/cm, such as less than about 18 N/cm, less than about 15 N/cm, less than about 10 N/cm, or less than about 5 N/cm, including all ranges and subranges therebetween. According to various embodiments, the mesh can have a fixed, uniform tension ranging from about 10 N/cm to about 20 N/cm, such as from about 11 N/cm to about 19 N/cm, from about 12 N/cm to about 18 N/cm, from about 13 N/cm to about 17 N/cm, or from about 14 N/cm to about 16 N/cm, including all ranges and subranges therebetween. In other embodiments, a range of fixed low tensions can be applied in both the warp and weft directions of the weave, which can be less than about 20 N/cm, such as less than about 18 N/cm, less than about 15 N/cm, or less than about 10 N/cm. According to further embodiments, the mesh can have a fixed, variable tension ranging from about 10 N/cm to about 20 N/cm, such as from about 11N/cm to about 19 N/cm, from about 12 N/cm to about 18 N/cm, from about 13 N/cm to about 17 N/cm, or from about 14 N/cm to about 16 N/cm, including all ranges and subranges therebetween.

As used herein, the term “fixed” tension is intended to denote that the screen has a given tension, whether uniform or variable, across the mesh area, which is not changed, e.g., by devices used to tension and de-tension the screen mesh during the printing process. Without wishing to be bound by theory, it is believed that the relatively low tension of the screen material (e.g., 2D framed screens utilize screens with an as-manufactured tension of greater than 20 N/cm, such as up to about 40 N/cm), can allow for high tension during printing due to the stretch of the screen, which can result in higher resolution printing capability, while also allowing the screen to stretch as necessary to make contact with the various portions of the three-dimensional substrate.

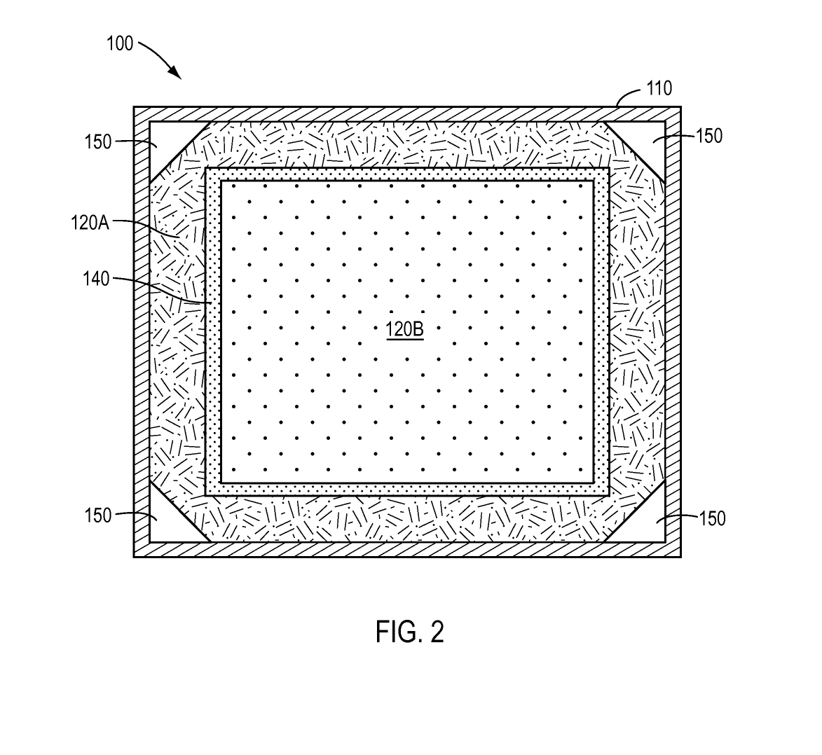

The screen 120 can, in certain embodiments, comprise more than one porous mesh material, or one or more porous mesh materials in combination with another stretchable material. These embodiments will be discussed with non-limiting reference to FIG. 2, which illustrates an exemplary framed screen apparatus 100 comprising a screen constructed from two different materials. An outer screen region 120A constructed from a first screen material can be attached to the frame 110 and can extend across a first portion of the surface area defined by the frame. The first screen material can be attached to a second screen material defining an inner screen region 120B extending across a second portion of the surface area.

For example, the first screen material can have a given flexibility (or ability to stretch) and the second screen material can have a flexibility higher than that of the first material. By way of a non-limiting example, an outer region 120A can be formed from, e.g., a porous polyester mesh, whereas the inner region 120B can be formed from a higher stretch porous mesh material such as nylon. Alternatively, the first screen material can be a porous mesh having a given flexibility and the second screen material can be a porous mesh having a flexibility lower than that of the first material, such as an outer region 120A formed from nylon and an inner region 120B formed from polyester.

In a further embodiment, the first material forming the outer region 120A can be a non-porous, flexible material or a porous, stretchable material not typically used for screen printing, and the inner region 120B can be formed from a flexible, porous mesh material as described herein, such as polyester or nylon, to name a few, or vice versa. The non-porous material can be any flexible material of any suitable thickness appropriate for high resolution printing including, but not limited to, silicone membranes. The porous, stretchable materials not typically used for screen printing can include, for instance, Spandex and Lycra.

According to various embodiments, the outer and inner regions 120A and 120B can meet at a juncture 140, at which point they are adhered or otherwise attached to each other in any manner suitable to maintain the integrity between the two materials during printing (e.g., such that the two materials do not separate at the junction). In certain embodiments, the juncture 140 has a minimal thickness that does not interfere, or does not substantially interfere, with the printing process. For instance, the two materials may be joined together using liquid adhesives, which can be, e.g., thermal set or UV set adhesives, double-sided tape, or combination of both on either side and/or in between the two materials. In further embodiments, the juncture 140 can be positioned in proximity to the edge of the three-dimensional substrate to be printed such that the junction does not interfere with the screen printing of the surface. For example, the location of the juncture 140 can be chosen such that it does not interfere with the flood stroke or print stroke of the printing medium applicator, e.g., squeegee, during the printing process.

While FIG. 2 illustrates one exemplary embodiment of a framed screen apparatus comprising two screen materials, it is to be understood that several variations can be made to this embodiment according to other aspects of the disclosure. For instance, more than two types of screen materials can be used and/or the shape and/or size of the frame and/or screen can be varied. Moreover, while an emulsion is not depicted on the screen 120 in FIG. 2, it is to be understood that such an emulsion can be present in any suitable pattern (see, e.g., FIG. 1).

It is also noted that in FIG. 2, the screen 120 does not fully cover the entire surface area defined by the frame 110, leaving voids 150 in the corners of the apparatus. In various embodiments, the screen 120 can cover more or less of the surface area and may have any desired shape, including one or more voids as depicted, in any quantity and/or location. By eliminating mesh in certain areas, it may be possible to reduce the resistance of the porous or non-porous material to stretching.

Further, while FIG. 2 illustrates an outer region 120A covering all sides of the frame perimeter, it is envisioned that the first screen material can be used to cover only a portion of the frame perimeter, for instance, only one, two, or three sides of the illustrated frame, or only portions of one or more sides, depending on the shape and/or radius or radii of the three-dimensional substrate to be printed. The variations of the size, shape, and/or number of such regions, including any voids, can vary depending on the frame and/or the substrate.

The screen 120 described herein can comprise one or more “porous” materials, which can denote that a liquid printing medium can pass through at least a portion of the screen upon application. For instance, a printing medium applicator, such as a squeegee, can be used to apply pressure to the screen, such that the printing medium passes through at least a portion of the screen and onto the substrate to be printed.

As noted above, at least a portion of the screen 120 can be coated with an emulsion 130 to form a pattern or image on the screen. The emulsion can, in some embodiments, block or substantially block the passage of the liquid medium through the coated portion of the screen. Accordingly, the pattern formed on the screen by the emulsion can, in some embodiments, be the reverse of the pattern printed on the substrate. Any emulsion compatible with the porous mesh screen material (including mesh count and thread diameter specification) and the liquid printing medium to be used can be contemplated within the scope of this disclosure. The emulsion can, for instance, be a liquid, and can have any density and/or capillary film properties. The emulsion may be coated onto the screen in any thickness suitable for screen printing applications. For instance, the emulsion may be coated onto the screen in a thickness that is up to about 50% of the thickness of the screen when attached to the frame, such as up to about 40%, up to about 30%, up to about 20%, or up to about 10% of the as-stretched thickness of the screen, including all ranges and subranges therebetween.

The emulsion 130 may be coated onto either or both sides of the screen 120. Moreover, the emulsion can coat any predetermined portion of the screen as desired to form the appropriate pattern or image on the three-dimensional substrate. In some embodiments, the screen can be defined in terms of a “print” or “stencil” area, in which the emulsion is purposefully removed to allow the liquid print medium to pass through the screen and onto the substrate. The remainder of the screen can, in various embodiments, be coated with the emulsion. In other embodiments, the flexibility of the screen can potentially be enhanced by removing the emulsion from areas of the screen other than the stencil area. For instance, the emulsion can be removed from the screen area just inside the frame perimeter to a distance in close proximity to the stencil area. The amount of emulsion present on the screen can vary depending on the desired image and/or the amount of screen flexibility desired. According to various embodiments, the screen area within about 5-10% of the frame perimeter can be free or substantially free of emulsion. For instance, referring to FIG. 2, it can be seen that a portion of the screen area near the frame perimeter is not coated with the emulsion.

In certain embodiments, a pattern can be formed on the screen by coating the entire screen with an emulsion, covering selected portions of the emulsion with a positive image film, and exposing the emulsion to UV radiation. The UV exposure can harden the exposed emulsion, whereas the emulsion covered by the film can remain soft, due to the film blocking the UV radiation. After hardening, the emulsion that was covered by the film can be washed away with water or any other suitable solvent for dissolving the emulsion. An image can thus be formed on the screen according to various embodiments of the disclosure.

The apparatuses disclosed herein may, in various embodiments, have one or more advantages such as cost savings, improved image resolution, and/or reduced mechanical complexity. For example, the disclosed apparatus can be utilized in standard 2D printing devices, using 2D process parameters and techniques (e.g., fixed screen and substrate location and/or substantially flat/planar frame) to print three-dimensional substrates, including convex and concave surfaces, single axis curvatures, biaxial curvatures, and compound curvatures for large format (e.g., greater than about 500 mm) substrates. Additionally, because the apparatuses can be used in standard printing devices, the need for custom tooling and machining and the expenses associated therewith can be eliminated. Moreover, because the substrate and frame locations can be fixed relative to each other, the need for additional moveable parts, e.g., for translating either the substrate or frame or both, can be eliminated, thereby cutting down on the cost and complexity of the printing process.

Furthermore, the framed screen apparatuses can also be “universal” in that one screen design can be used for any of the various curvatures noted above. Since the apparatus comprises a highly flexible screen attached to a rigid frame, the apparatus can be used on substrates of various sizes. In other words, if the size of the three-dimensional substrate increases it may not be necessary to likewise increase the size of the framed screen apparatus to accommodate the larger surface. This attribute may be advantageous because it can avoid the need for larger and more expensive printing machines otherwise needed to accommodate larger framed screens. It should be understood that the apparatuses according to the present disclosure may not exhibit one or more of the above advantages, but are still intended to fall within the scope of the disclosure.

Systems

Disclosed herein are systems for screen printing on a surface of a three-dimensional substrate comprising a framed screen and an applicator for applying a liquid printing medium to the three-dimensional substrate, wherein the framed screen comprises a substantially rigid, substantially planar frame having a perimeter defining a region within the perimeter having a given surface area; and a screen attached to the frame and extending across at least a portion of the surface area, wherein the screen comprises a first portion through which a liquid printing medium can pass onto a proximate three-dimensional substrate; and a second portion coated with an emulsion substantially preventing the liquid printing medium from passing through the second portion of the screen, wherein the screen has a fixed tension of less than about 20 N/cm.

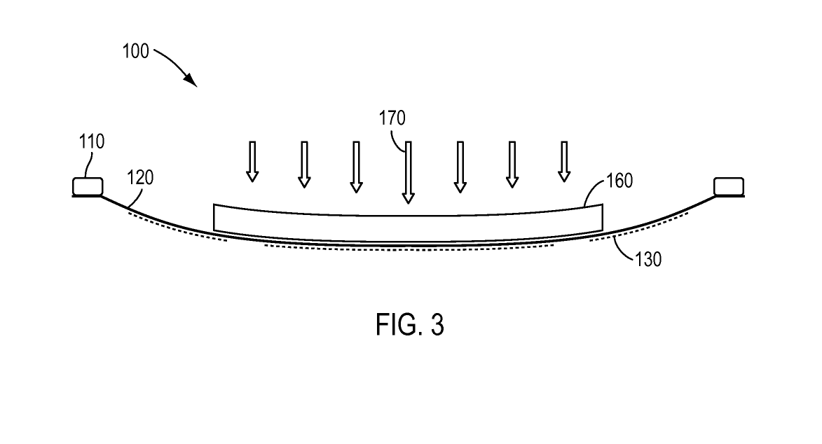

FIG. 3 illustrates a cross-sectional side view of screen printing system according to one aspect of the disclosure, in which an applicator 160 is brought into contact with a framed screen apparatus 100. The screen 120 is attached to the frame 110 and coated, at least in part, with an emulsion 130. In the illustrated embodiment, the emulsion 130 is coated on the lower surface of the screen 120, also referred to as the “printing” surface, although it is contemplated that the emulsion can also be coated onto the upper surface of the screen, also referred to as the “applicator” surface, or both. The liquid printing medium (not shown) can be applied to the screen and, using the applicator 160 to apply pressure to the screen, as represented by the arrows 170, at least a portion of the liquid printing medium can pass through the screen and onto the three-dimensional substrate. The applicator 160 may be flexible or rigid and the application pressure may be uniform or variable.

According to one exemplary embodiment, a flexible, pressure controlled applicator, such as a squeegee, may be used to print on the three-dimensional substrate, e.g., for substrates with complex curvature around more than one radius. A standard straight-edge squeegee, such as those used for 2D flat printing may also be used to print on the three-dimensional substrate, e.g., for substrates with a single radius of curvature. Other applicators such as brushes, spatulas, or the like, of varying shapes and sizes, are also contemplated and within the scope of the disclosure. The squeegee or any other applicator can be drawn along the screen, forcing at least some of the printing medium through at least a portion of the screen onto the three-dimensional substrate. The hold angle, pressure, draw speed, size, and hardness of the applicator can vary depending, e.g., on the desired image resolution.

According to various embodiments, the applicator can be a squeegee, which can comprise any material, such as rubber materials, polyurethanes, and the like. The applicator can be a single unit, such as a single squeegee, or can comprise segmented units, such as two or more adjacent or non-adjacent squeegees. In some embodiments the applicator may comprise a single piece which may, in various embodiments, be rectangular in shape, or can comprise multiple pieces. The applicator, e.g., squeegee, may comprise a working edge, which contacts the screen, optionally at an angle, and a fixed edge, which may be opposite the working edge and can be attached to the printing device using any suitable means. In non-limiting exemplary embodiments, the applicator can be a squeegee such as those disclosed, e.g., in U.S. Provisional Patent Application No. 62/032,138, entitled SQUEEGEE FOR PRINTING FLAT AND CURVED SUBSTRATES, filed by Applicant on Aug. 1, 2014, which is incorporated herein by reference in its entirety.

The printing medium can be a medium comprising one or more coloring agents, such as pigments, dyes, and the like. The printing medium can be in a liquid or substantially liquid form and can comprise at least one solvent, such as water, or any other suitable solvent. As used herein, the term “liquid” is intended to refer to any free-flowing medium having any viscosity suitable for screen printing. In certain embodiments, the liquid printing medium can be chosen from inks of various colors and shades. In other embodiments, the liquid printing medium can be chosen from non-pigmented mediums, such as clear lacquers or protective coatings, to name a few. The liquid printing medium can be chosen from colored, opaque, translucent, or transparent mediums and may serve a functional and/or decorative purpose.

The systems disclosed herein can further comprise various additional components. For example, a printing medium delivery component may be included, which can be configured to deliver a pre-determined amount of printing medium onto the screen. A distributor, such as a flood bar, may optionally be employed to distribute the printing medium across the screen, for example, in a substantially even fashion. Further, a means for gripping and/or translating the applicator can be included, as well as various other components typically present in a screen printing device.

Methods

Further disclosed herein are methods for screen printing a surface of a three-dimensional substrate comprising positioning the three-dimensional substrate in proximity to a framed screen, the framed screen comprising a substantially rigid, substantially planar frame having a perimeter defining a region within the perimeter having a given surface area; and a screen attached to the frame and extending across at least a portion of the surface area, wherein the screen comprises a first portion through which a liquid printing medium can pass onto a proximate three-dimensional substrate; and a second portion coated with an emulsion substantially preventing the liquid printing medium from passing through the second portion of the screen, wherein the screen has a fixed tension of less than about 20 N/cm; and applying pressure to the screen to force a portion of the liquid printing medium through the first portion of the screen onto the three-dimensional substrate, wherein the distance between the frame and the three-dimensional substrate is held substantially constant during the application steps.

The methods disclosed herein can be used to print or decorate a three-dimensional substrate. Decorating or printing as disclosed herein can be used to describe the application of a coating, which can be functional and/or aesthetic, of any liquid material having any suitable viscosity onto a three-dimensional substrate. The three-dimensional substrate can be chosen from substrates of varying compositions, sizes, and shapes. For example, the substrate may comprise a glass, ceramic, glass-ceramic, polymeric, metal, and/or plastic material. Exemplary substrates can include, but are not limited to, glass sheets, molded plastic parts, metal parts, ceramic bodies, glass-glass laminates, and glass-polymer laminates.

The three-dimensional substrate may have any shape or thickness, for instance, a thickness ranging from about 0.1 mm to about 100 mm or more, depending, e.g., on the size and/or orientation of the printing device. For instance, the three-dimensional substrate may have a thickness ranging from about 0.3 mm to about 20 mm, from about 0.5 mm to about 10 mm, from about 0.7 mm to about 5 mm, from about 1 mm to about 3 mm, or from about 1.5 mm to about 2.5 mm, including all ranges and subranges therebetween. The three-dimensional substrate may have a single radius of curvature or multiple radii, such as two, three, four, five, or more radii. The radius of curvature may, in some embodiments, be greater than about 500 mm, such as greater than about 600 mm, greater than about 700 mm, greater than about 800 mm, greater than about 900 mm, or greater than about 1,000 mm, including all ranges and subranges therebetween.

According to the methods disclosed herein, a liquid printing medium can be applied to and optionally spread across the screen using any means described herein. An applicator may then be used to apply pressure to the screen to force a portion of the liquid printing medium through at least a portion of the screen onto the three-dimensional substrate. According to various embodiments, the applicator can contact the screen in a single pass, which may be sufficient to transfer the liquid printing medium to the three-dimensional substrate, or the applicator can make several passes. Any applicator as described herein can be used to carry out the disclosed methods.

As used herein, the term “off-contact” distance is intended to refer to the distance between the substantially rigid, planar frame and the substrate surface. Off-contact also refers to the distance at which the screen is held away from the substrate both immediately prior to printing and immediately after printing. In other words, the off-contact distance is the distance the screen must travel to contact the substrate. According to the methods disclosed herein, the distance between the frame and the three-dimensional substrate is held substantially constant during the application of the liquid printing medium and the application of pressure. The frame and the substrate can be held in fixed positions relative to each other. When pressure is applied to the screen, e.g., using an applicator, the screen can move to contact the substrate, but the frame can be held in substantially the same position. The off-contact distance can be greater than the off-contact distance used for 2D printing (e.g., about 1-10 mm) and can theoretically be unlimited using the methods disclosed herein. By way of non-limiting example, the off-contact distance can be greater than about 100 mm, greater than about 75 mm, greater than about 50 mm, greater than about 25 mm, or greater than about 10 mm, including all ranges and subranges therebetween.

After the printing medium is applied to the three-dimensional substrate, various additional steps can be performed such as, for example, drying the printed medium to remove one or more solvents, curing the printed medium, removing the substrate from the printing machine, placing the substrate under vacuum, and/or cleaning the substrate, to name a few. According to various embodiments, the pattern can be corrected and/or adjusted using the methods disclosed, e.g., in U.S. Provisional Patent Application No. 62/032,125, entitled METHODS FOR SCREEN PRINTING THREE-DIMENSIONAL SUBSTRATES AND PREDICTING IMAGE DISTORTION, filed by Applicant on Aug. 1, 2014, which is incorporated herein by reference in its entirety.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “an emulsion” includes examples having two or more such emulsions unless the context clearly indicates otherwise. Likewise, a “plurality” is intended to denote “more than one.”

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote an object that is planar or approximately planar. Moreover, as defined herein, “substantially similar” is intended to denote that two values or objects are equal or approximately equal.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a system that comprises A+B+C include embodiments where a system consists of A+B+C and embodiments where a system consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A screen printing apparatus for printing on a surface of a three-dimensional substrate, the apparatus comprising:
(a) a substantially rigid, substantially planar frame having a perimeter defining a region within the perimeter having a given surface area; and
(b) a screen attached to the frame and extending across at least a portion of the surface area, the screen comprising:
(i) a first portion through which a liquid printing medium can pass onto a proximate three-dimensional substrate; and
(ii) a second portion coated with an emulsion substantially preventing the liquid printing medium from passing through the second portion of the screen; wherein the screen has a fixed tension of less than about 20 N/cm.

2. The screen printing apparatus of claim 1, wherein the screen comprises at least one porous mesh material.

3. The screen printing apparatus of claim 2, further comprising at least one non-porous material.

4. The screen printing apparatus of claim 1, wherein the screen comprises at least one material chosen from polyesters, nylons, PETs, polyamides, polyester core/sheath combinations, composite polyester materials, and coated polyesters.

5. The screen printing apparatus of claim 1, wherein the screen comprises one or more of:
(i) a plain, twill, double twill, crushed, or flattened weave pattern;
(ii) a mesh count ranging from about 120 threads/inch to about 380 threads/inch; or
(iii) a thread diameter ranging from about 30 microns to about 80 microns.

6. The screen printing apparatus of claim 1, wherein the screen has a fixed tension ranging from about 13 N/cm to about 18 N/cm.

7. The screen printing apparatus of claim 1, wherein the emulsion is treated with UV radiation.

8. A screen printing system for printing a surface of a three-dimensional substrate, the system comprising:
(a) a screen printing apparatus as defined in claim 1; and
(b) at least one applicator for applying a liquid printing medium to the three-dimensional substrate.

9. The screen printing system of claim 8, wherein the at least one applicator is chosen from flexible and rigid squeegees.

10. The screen printing system of claim 8, further comprising at least one of a liquid printing medium delivery device and a liquid printing medium distributor.

11. A method for screen printing a surface of a three-dimensional substrate, the method comprising the steps of:
(a) positioning the three-dimensional substrate in proximity to a framed screen, the framed screen comprising:
(i) a substantially rigid, substantially planar frame having a perimeter defining a region within the perimeter having a given surface area; and
(ii) a screen attached to the frame and extending across at least a portion of the surface area,
wherein the screen comprises:
a first portion through which a liquid printing medium can pass onto the three-dimensional substrate; and
a second portion coated with an emulsion substantially preventing the liquid printing medium from passing through the second portion of the screen, and
wherein the screen has a fixed tension of less than about 20 N/cm;
(b) applying the liquid printing medium to the screen; and
(c) applying pressure to the screen to force a portion of the liquid printing medium through the first portion of the screen onto the three-dimensional substrate,
wherein the distance between the frame and the three-dimensional substrate is substantially constant during the application steps.

12. The method of claim 11, wherein the three-dimensional substrate comprises at least one of a glass, ceramic, glass-ceramic, metal, plastic, or polymeric material.

13. The method of claim 11, wherein the distance between the frame and three-dimensional substrate ranges from about 10 mm to about 100 mm.

14. The method of claim 11, wherein the screen has a fixed tension ranging from about 13 N/cm to about 18 N/cm.

15. The method of claim 11, wherein the application of pressure is carried out using at least one squeegee.
